(19) United States
(12) Patent Application Publication
(10) Pub. No.: US 2006/0117977 A1
(43) Pub. Date: Jun. 8, 2006

(54) Method and apparatus for cleaning cylinders of a printing press

(75) Inventors: Rune G. Vestman, Zwingenberg (DE); Kjell E. Lundin, Zwingenberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Oxy-Dry Maschinen GmbH, Egelsbach (DE)

(21) Appl. No.: 11/281,760

(22) Filed: Nov. 17, 2005

(30) Foreign Application Priority Data
Nov. 30, 2004 (EP) 04 028 282.4

(51) Int. Cl. B41F 35/00

(52) U.S. Cl. 101/425

(57) ABSTRACT

A method and apparatus for cleaning cylinders of a printing press with at least one automated washing device (1), which is controlled by a controller (2) with a washing sequence program, which can be selected automatically or manually and which also can be started automatically, delayed, or manually. According to the invention, there is a sensor (3), which interacts with the controller and which scans the surface of the cylinder to be cleaned or the print substrate (4) leaving the cylinder using a non-contact method. This sensor influences the start and/or the selection of the washing sequence program, in which the amount of soiling is estimated from the sensor signals and/or the amount of soiling is forecast or the course of the amount of soiling is forecast from the time profile of the sensor signals and the selection of the best suited washing sequence program and/or the best suited starting time is determined depending on the estimated current amount of soiling and/or depending on the forecast amount of soiling.

### BACKGROUND

The invention relates to a method and to an apparatus for cleaning cylinders of a printing press using an automated washing device that is controlled by a controller with a washing sequence program, in which the start of the washing sequence program and/or the selection of one of multiple washing sequence programs is performed automatically, can be automatically delayed, or is controlled manually.

Here, printing presses refer, in particular, to newspaper web printing presses, commercial web printing presses, and sheet fed printing presses for all printing methods, such as offset printing, anilox offset printing, intaglio printing, flexographic printing, anilox-flexographic letterpress printing, and roto gravure printing. The cylinders to be cleaned are understood to be all rollers, rolls, and cylinders of a printing press, especially rubber blanket cylinders, impression cylinders, plate and form cylinders, chill rollers, guide rollers, and also inking rollers.

The common feature for all of the mentioned printing presses is that an intensive contact between the print and the cylinder is necessary for guiding, for processing, and for running print sheets or print webs. Therefore, when paper is used as the print media, deposits of lint (fibers, coat, fillers, etc.), printing inks, and possibly powder accumulate on the cylinders. These deposits negatively affect the function of the cylinders; for example, deposits on rubber blanket cylinders in offset printing lead to the loss of point sharpness of the print and some of the print areas will not print out correctly. However, just for rubber blanket cylinders, the deposit build-up rate is especially high due to the high viscosity and adhesiveness of the printing ink. Therefore, for the print quality and also the operational reliability, it is imperative that the mentioned cylinders are regularly cleaned from soiling.

Besides the cleaning of cylinders by hand, which is still carried out, for some time automated washing devices have been used for this purpose, such as the washing device described in EP 0 419 289 A2. Such an automated washing device is essentially composed of a brush roller that can be moved onto the cylinder to be cleaned, nozzle tubes for spraying washing fluid on the brush roller, feeds for the washing fluid, and a controller for the individual functions. If several washing devices are provided in a printing press, then they can be controlled by a central control unit, which enables the washing devices to be controlled remotely from a central control panel.

In U.S. Pat. No. 6,109,182, a method for fully automatic cylinder cleaning in printing presses with a central control system is disclosed. According to this state of the art, the control system is expanded by a control function, wherein a plurality of washing sequence programs are stored and the selection, as well as optionally the time of the start of a washing sequence program for a certain washing device, is automatically set by accessing the data of the central printing press control system.

However, primarily for commercial, web fed, and sheet fed printing presses, it has become common to let the cylinder cleaning run automatically usually after enabling a manual start and selection of the individual washing programs, i.e., not fully automatically.

In practice, this has led to the fact that the cylinders are cleaned sometimes too often, and usually with a more intensive washing sequence program than necessary, because a washing sequence program that is too weak only loosens the ink on the cylinder, for example, for a rubber blanket cylinder, and does not sufficiently reduce the adhesion of the printing ink and, for example, for washing in a web offset printing press, can lead to the risk of a web break.

However, a washing sequence program that is too intensive or started earlier than necessary can also lead to problems, because the amount of soiling on the cleaned cylinder does not correspond to the amount of applied washing fluid and accordingly, a certain amount of washing fluid does not bind to the soiling. In the worst case, this leads to clouds of mist spraying and splashes into the surroundings of the cylinder and onto other machine parts. In particular, a cloud of washing fluid mist can condense on various locations in the printing press, can possibly collect in these locations, and then can drop onto the print; this leads to the production of wasted paper, which can occasionally occur during production, i.e., is nearly impossible to rule out.

For production washing on the fly, there is the risk that the print substrate absorbs too much washing fluid, especially water, and consequently there is the risk of the web breaking in for web printing presses, and in turn, the risk of production downtime.

### SUMMARY

Therefore, the present invention is based on the objective of reliably preventing, for the first time, unnecessary or unnecessarily intense washing processes as well as optimizing the time and/or the intensity of the washing process for a process and an apparatus of the above-noted type.

This problem is addressed by a method as well as by an apparatus according to the invention.

According to the present invention, as before, an automated washing device is provided, which is controlled by a controller with a washing sequence program. The washing sequence program can be set in advance or several different washing sequence programs set in advance can be stored in the controller. It can also be advantageous if the controller itself generates a washing sequence program with reference to data of current initial conditions based on a predetermined algorithm in order not to be limited to a limited number of preset washing sequence programs. The start of the washing sequence program and/or the selection of one of several washing sequence programs can be carried out automatically or manually, wherein, for example, a manual start is enabled only when the washing of a cylinder is useful. Here, a manual start can also be automatically delayed, wherein the controller notices the manual start command and moves the start to the earliest possible useful time. Here, mixed forms are also conceivable, for example, where the controller automatically corrects a manual selection and a manual start of a washing sequence program with respect to the selection.

The common feature for all of the variants is that, as the main difference with the prior state of the art, there is a sensor, which interacts with the controller and which scans the surface of the cylinder to be cleaned or the print substrate leaving this cylinder using a non-contact method. This sensor can be, for example, a known monitoring sensor that is possibly already provided in the printing press for a closed loop ink density control of the printing press. The signals of this sensor are also used for the method according to the invention.

The expanded washing system controller then estimates the amount of soiling on the cylinder to be cleaned with reference to the signals obtained from the sensor, after which, depending on this estimated amount of current soiling, the best suited washing sequence program is selected and/or the best suited starting time for the start of the washing sequence program is determined. According to one variant of the invention, the sensor signals are evaluated by the washing system controller, such that from the time profile of the sensor signals, the amount of soiling at a certain future time or the accumulation of the amount of soiling is forecast and this forecast is used for the selection and/or for the best suited starting time of the washing sequence program. Here, mixed forms of operation are also included, that is, the consideration of the estimated current amount of soiling in addition to the consideration of the forecast amount of soiling at a future time or the course of the amount of soiling for the selection and/or the most favorable start for a washing sequence program.

Here, it is advantageous if additional operating parameters of the printing press are considered for the selection or the starting time of the washing sequence program, such as particularly the time for a paper roll change or otherwise planned pauses in production.

According to the invention, the inclusion of a sensor for estimating or forecasting of the amount of soiling naturally offers very high reliability for the estimated or forecast data relative to standard estimating or forecasting based not just on the known machine and production data. In addition, the type of soiling on the cylinder of a printing press also depends on how the printer in charge operates the printing press.

The start and/or the selection of the washing sequence program can be influenced by the signals of the sensor in such a way that the start of a certain washing sequence program is enabled, delayed, or automatically performed only above a threshold value of the estimated amount of soiling. Here, the threshold value can be fixed. In contrast, it is especially advantageous when the threshold value can be preset, thus it can be adapted to the appropriate conditions on site. As long as only one washing sequence program is provided in the controller, or as long as the washing sequence program is generated in the controller in real time by the use of an algorithm, then according to this configuration of the invention, when a predetermined or preset threshold value of the amount of soiling estimated with reference to the sensor signals is reached or exceeded, the washing sequence program is started, generated, or enabled, for example, for a manual start, optionally with an automatically generated delay. If the controller of the washing device or washing devices keeps multiple washing sequence programs stored, then corresponding to the estimated or forecast amount of soiling, a certain washing sequence program can be selected. In this case, the invention can also be used, such that, for multiple washing sequence programs with stepped intensity, one or more washing sequence programs can be enabled, for example, for a manual start, only when one of several threshold values allocated to the washing sequence program has been reached.

In order to achieve that the produced paper waste during a cleaning process is kept at a minimum, it can be advantageous to not wait until the just mentioned threshold value for the soiling on the cylinder to be cleaned has been reached or exceeded, since paper waste will be produced already before the start of a washing sequence program, but instead a threshold value time, at which a predetermined or preset threshold value of the estimated amount of soiling will be exceeded, is forecast with reference to the signals of the sensor and with reference to the time profile of these signals, while a washing sequence program is started at a starting time, which is prior to the threshold value time approximately by the period needed by the selected washing sequence program to be finished working. According to how the time differential of the profile for the estimated amount of soiling proceeds, for example, if it increases, then it can be useful, especially for a foreseeable paper roll change shortly before reaching the threshold value, to select the starting time earlier or possibly also later, that is, closer to the threshold value time.

Depending on this condition, the start of a washing sequence program can be executed earlier in time in each case, if the increase in the amount of soiling is forecast to accelerate with time.

Also, if the control of several washing devices provided in a printing press is implemented fully automatically from the control station of the printing press, then according to the invention, the estimation and forecasting of the amount of soiling on the individual cylinders to be cleaned through the use of a sensor can be used as a correction or for refining the forecast obtained from the other operating parameters on the amount of soiling on the cylinders to be cleaned.

Both for printing presses with central control stations, and also for other printing presses, for which, for example, the path of the print substrate through the printing press is fixed in advance, it is advantageous if the start and/or the selection of a washing sequence program is chosen, in addition to the consideration of the amount of soiling estimated or forecast by means of the sensor signals according to the invention, also by considering additional parameters, such as the rotational speed of the cylinder to be cleaned, the presence of cylinder-print substrate contact during cleaning, the print substrate type, thus, usually the paper type, the ink type, or the amount of fountain solution used during printing.

As already mentioned above, the consideration of the sensor signals according to the invention is realized in such a way that a washing sequence program and/or the time for its start is determined not optimized in terms of the cleaning result, but instead in terms of the minimum necessary period possible for the cleaning process and/or its starting time. This is realized under consideration of the forecast future course of the amount of soiling and under consideration of additional production data of the printing press, thus, especially under consideration of an interruption in production known in advance due to a paper roll change or a stoppage for installing new printing plates. This is because the washing devices can run during otherwise occurring interrupts in production or stoppages of the printing press and thus minimized or possibly no paper waste is created. This refinement of the invention is to be understood with the background that the cleanliness of the cylinder of a printing press, and thus finally the printed image, is not always optimal, but instead merely has to be within a certain tolerance. Only when the amount of soiling exceeds a certain threshold value, at which the printed image becomes too poor, must it be treated; but also, according to the conditions or circumstances, it is not always best to achieve the optimum cleaning result, for example, if it is not all that long until the next production stoppage, but instead, in this case, it can be useful, for example, to clean only weakly, but in this way only taking up very little time in order to keep the printed image within a tolerable range until the next production stoppage. Under certain initial conditions, a similar optimization consideration also leads to an advantageous configuration of the invention, according to which already significantly before reaching a still tolerable amount of soiling, a complete cleaning is performed by starting a corresponding washing sequence program, so that the amount of soiling and thus, in conjunction, the print quality remain better on average until the next planned production stoppage.

As a sensor, a monitoring sensor already provided in the printing press is especially preferred, especially a monitoring sensor for the ink density control of the printing press; because this already interacts with the ink density control so that it forms a closed loop control, wherein its signals detected through optical scanning of the printed image on the print substrate leaving the cylinder to be cleaned are used as control parameters for the ink density. For realizing the invention, only the control of this monitoring system must be connected to the control of the automated washing device, so that the signals of the monitoring sensor affect the start and/or the selection of the washing sequence program for the washing device according to the invention.

The estimation of the amount of soiling is preferably program controlled through comparison of the signals of the sensor with a stored plurality of sensor signal patterns, wherein for each stored sensor signal pattern, a typical amount of soiling is stored and the best match of the measured sensor signal pattern created by the use of an algorithm with one of the stored sensor signal patterns enables the estimation of the amount of soiling according to the invention.

The sensor provided according to the invention can be an optical sensor, especially with a (digital) camera, with which, for example, a dot enlargement in the printed image on the print substrate leaving the cylinder to be cleaned can be optically detected, or with a laser.

As an alternative to an optical principle in the sensor provided according to the invention, the scanning of the surface of the cylinder to be cleaned or the print substrate can be implemented with capacitive, or by means of a sound-wave reflection or a sound-wave transmission sensor.

The control of the apparatus according to the invention can be integrated as a software module in the controller of the washing system or in a controller of other already provided control systems, such as the control for ink density. This saves costs and maintenance expense.

### BRIEF DESCRIPTION OF THE DRAWINGS

One embodiment for an apparatus according to the invention is described and explained in more detail below with reference to the accompanying drawings. In the drawings:

FIG. 1 is a schematic view showing an example of a system according to the invention;

FIG. 2 is a flow chart that shows the function of the embodiment from FIG. 1; and

FIG. 3 is a a schematic representation for visualizing an increase in a printing dot.

### DETAILED DESCRIPTION OF THE PREFERRED EMBODIMENT

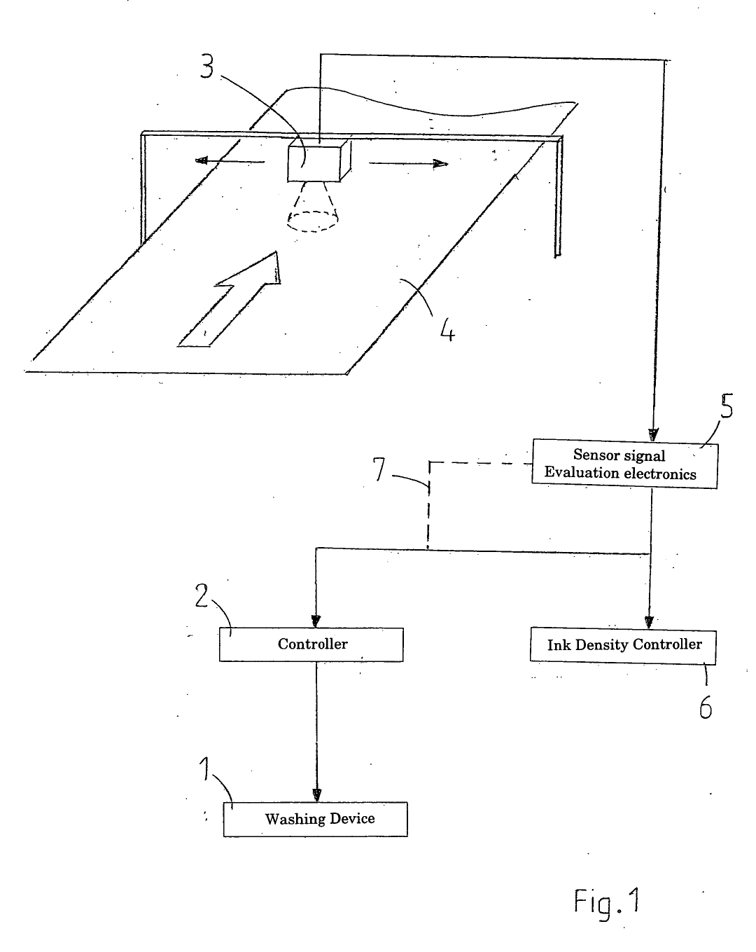

In FIG. 1, the principle construction of a first preferred embodiment for an apparatus according to the invention is shown schematically. A washing device 1 is controlled by a controller 2, wherein the controller 2 is influenced by the signals of an image-forming sensor 3, which optically scans a paper web 4 used as a print substrate, by means of sensor signal evaluation electronics 5. The sensor 3 includes an ink density sensor head, which moves transversely over the paper web 4 moving under it and which measures the ink density of the printed image. The sensor signal evaluation electronics 5 calculates the control variables for the control loop of an ink controller 6 of the printing press, and is therefore already provided in the printing press. Simultaneously, the sensor signals are branched from the evaluation electronics 5 to the controller 2 of the washing device 1, wherein, if necessary, a signal path 7—shown with dashed lines—is provided, so that the controller 2, which is provided in the present as a software module, can act on the sensor signal evaluation electronics 5, in order to generate the data necessary for the control of the washing device 1 as well as especially the selection of washing sequence programs and the start of these programs.

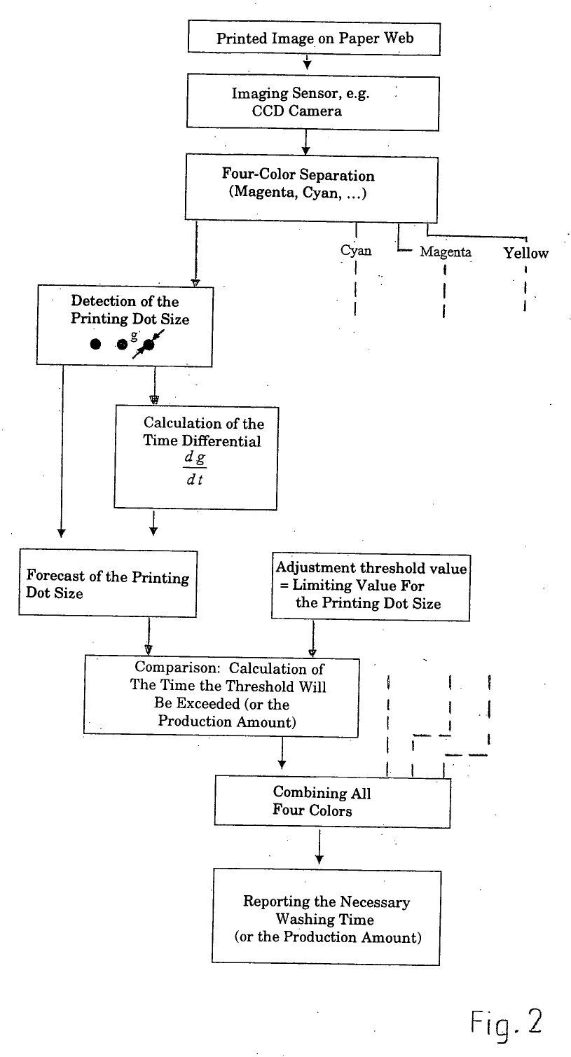

FIG. 2 is a flow chart, which explains the function of the construction shown in principle in FIG. 1. The printed image on the paper web 4 scanned by the image-forming sensor 3, here a CCD camera, or the corresponding digital signals are divided in the sensor signal evaluation electronics 5 first into the color tones of black, cyan, magenta, and yellow, after which, the corresponding printing dot size “g” is detected for these inks separately. The controller 2 takes the detected printing dot size as a measure for the amount of soiling on the cylinder to be cleaned and calculates in parallel from the time course of the detected printing dot sizes the time differential dg/dt, in order to calculate from this value, together with the current measured printing dot size, a forecast for the future increase of the printing dot size.

When a certain limiting value, which here can be preset, for the printing dot size is reached, then for the embodiment shown here, this is used as a threshold value for the amount of soiling, for which the corresponding cylinder of the printing press must be cleaned. Therefore, the controller 2 compares the current measured printing dot sizes with the set limiting value and calculates with reference to the calculated forecast for the future course of the increase in the printing dot size the threshold value point in time, at which the printing dot size will probably exceed the set limiting value. This calculation is performed separately for all colors, after which the corresponding threshold value times are again set with reference to each other and then using these values, the time is calculated for cleaning the cylinder or the multiple cylinders controlled from the present controller 2. Then, under consideration of additional parameters of the printing press, with reference to the reporting of these results (this sequence is no longer shown in FIG. 2), it is automatically decided by the controller 2 when and with which washing sequence program the washing device 1 is started.

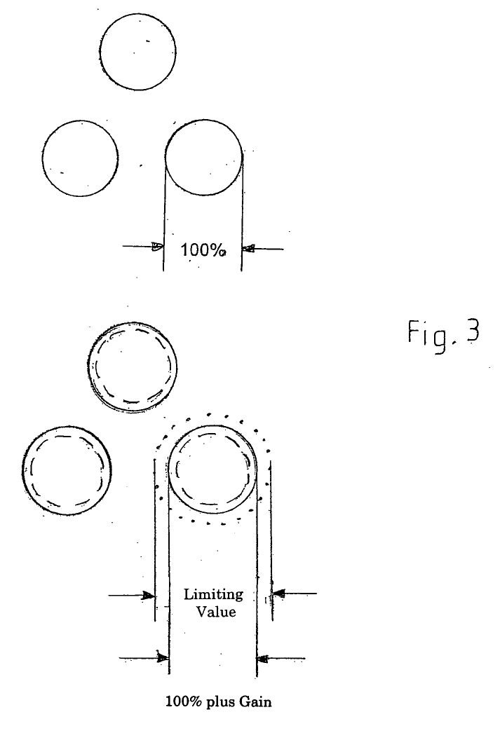

FIG. 3 again shows schematically the increase of the printing dot size, which is used as a measure for the amount of soiling on a rubber blanket cylinder.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention as defined by the appended claims. It is also noted that the reference to “at least one” of two or more items recited in the claims (such as A, B and C) means any individual one of the recited items (A, B, or C) or any combinations thereof for the so designated items.

1. Method for cleaning cylinders of a printing press using at least one automated washing device, comprising:
providing a washing device that is controlled by a controller with at least one washing sequence program;
scanning a surface of at least one of a cylinder to be cleaned or a print substrate leaving the cylinder using a non-contact sensor and generating a sensor signal;
controlling at least one of a start of or a selection of the at least one washing sequence program in part utilizing the sensor signal;
creating an estimation in the controller of at least one of an amount of soiling on the cylinder to be cleaned from the sensor signal, a forecast for the amount of soiling at a certain future time, or a forecast for a course of the amount of soiling from a time profile of the sensor signals; and
the controller selecting at least one of a best suited washing sequence program and a best suited starting time for cleaning the cylinder.

2. Method according to claim 1, further comprising
the controller enabling, delaying or automatically initiating the start of the washing sequence program only after a predetermined or preset threshold value of the estimated amount of soiling is met.

3. Method according to claim 1, further comprising
the controller forecasting a threshold value point in time at which a predetermined or adjustable threshold value of the estimated amount of soiling will be exceeded; and
the controller starting the washing sequence program at a starting time, which is before the threshold value point in time approximately by a period required by the selected washing sequence program.

4. Method according to claim 1, further comprising
the controller initiating the washing sequence program at an earlier time when an increase in the amount of soiling is forecast to accelerate with time.

5. Method according to claim 1, further comprising
the controller receiving at least one other parameter including at least one of a rotational speed of the cylinder to be cleaned, a presence of cylinder-print substrate contact during the washing process, a print substrate type, an ink type, or an amount of fountain solution; and
using the at least one other parameter in addition to the estimated amount of soiling in selecting the at least one of the start of or the selection of the at least one washing sequence program.

6. Method according to claim 1, wherein the at least one of the start or the selection of the washing sequence program is influenced by the signals of the sensor based on consideration of a forecast future course of the amount of soiling, and the method further comprises:
the controller receiving other production data of the printing press, including at least one of an interruption in production due to paper roll change or installation of new printing plates; and
the selecting of the at least one of the washing sequence program or the time for a start thereof is determined optimized not in terms of the cleaning result, but instead in terms of a minimum possible period necessary for the cleaning process.

7. Method according to claim 1, wherein
a monitoring sensor for ink density control of the printing press is used as the sensor.

8. Method according to claim 1, wherein
the amount of soiling is estimated by comparing the signals of the sensor with a stored plurality of sensor signal patterns.

9. Method according to claim 1, wherein
scanning of the surface of the cylinder to be cleaned or the print substrate is carried out optically with a camera or a laser.

10. Method according to claim 9, further comprising
optically detecting a printing dot gain in a printed image on print substrate leaving the cylinder to be cleaned using the sensor.

11. Method according to claim 1, wherein
scanning of the surface of the cylinder to be cleaned or of print substrate is realized using capacitance or sound-wave reflection or transmission.

12. Method according to claim 1, further comprising
selecting the washing sequence program such that the controller generates a washing sequence program based on the sensor signals using a predetermined algorithm.

13. Method according to claim 1, further comprising
selecting the washing sequence program from a number of predetermined washing sequence programs.

14. Apparatus for cleaning cylinders of a printing press, comprising
at least one automated washing device (1) and a controller (2) for the automated washing device, the controller controls the washing device which includes at least one washing sequence program that can be selected automatically or manually;
a sensor (3), which interacts with the controller and which scans at least one of a surface of a cylinder to be cleaned or print substrate (4) leaving the cylinder using a non-contact method;
the controller estimates at least one of an amount of soiling on the cylinder to be cleaned using signals from the sensor, forecasts the amount of soiling at a certain future time, or forecasts a course of the amount of soiling from a time profile of the sensor signals; and
the controller being adapted to select at least one of a best suited washing sequence program or a best suited starting time depending on at least one of the estimated current amount of soiling or the forecast amount of soiling.

15. Apparatus according to claim 14, wherein
the controller (2) is equipped to enable, delay, or automatically perform the start of the washing sequence program after a predetermined or adjustable threshold value of the estimated amount of soiling is met.

16. Apparatus according to claim 14, wherein
the controller (2) is equipped so that it forecasts a threshold value time, at which a predetermined or adjustable threshold value of the estimated amount of soiling is exceeded and a washing sequence program starts at a starting time, which is before the threshold value time approximately by a period needed for the selected washing sequence program.

17. Apparatus according to claim 14, wherein
the controller (2) is equipped so that it advances the start of the washing sequence program when it forecasts that an increase in an amount of soiling will accelerate with time.

18. Apparatus according to claim 14, wherein
the controller (2) is equipped so that the start and/or the selection of the washing sequence program is influenced, in addition to the estimated amount of soiling, also by other parameters including at least one of a rotational speed of the cylinder to be cleaned, a presence of a cylinder-print substrate contact during the washing process, a print substrate type, an ink type, or an amount of fountain solution used during printing.

19. Apparatus according to claim 14, wherein
the controller (2) is equipped so that it sets the washing sequence program and/or the time for its start optimized not in terms of a cleaning result, but instead in terms of a minimum possible period necessary for the cleaning process in view of a forecast future course of the amount of soiling and under consideration of other production data of the printing press, including an interruption time due to a paper roll change or due to installation of new printing plates.

20. Apparatus according to claim 14, wherein
the sensor (3) comprises a monitoring sensor for ink density control (6) of the printing press.

21. Apparatus according to claim 14, wherein
the controller (2) contains a stored plurality of sensor signal patterns and is equipped so that it estimates the amount of soiling by comparing the signals of the sensor with the stored plurality of sensor signal patterns.

22. Apparatus according to claim 14, wherein
the sensor (2) comprises an optical sensor using a camera or a laser.

23. Apparatus according to claim 22, wherein
the sensor (3) is equipped to optically detect a printing dot gain in a printed image on the print substrate (4) leaving the cylinder to be cleaned.

24. Apparatus according to claim 14, wherein
the sensor (3) is a capacitive or acoustic sensor.

25. Apparatus according to claim 14, wherein
the controller (2) comprises a software module.

26. Apparatus according to claim 14, wherein
the controller (2) selects the washing sequence program based on a predetermined algorithm in view of the sensor signals.

27. Apparatus according to claim 14, wherein
a number of predetermined washing sequence programs are stored in the controller (2), and the washing sequence program is selected from one of the stored washing sequence programs.
